(19) United States
(12) Patent Application Publication
(10) Pub. No.: US 2024/0165989 A1
(43) Pub. Date: May 23, 2024

(54) VEHICLE WHEEL

(71) Applicant: TOYOTA JIDOSHA KABUSHIK! KAISHA, Toyota-shi Aichi-kent (JP)

(72) Inventors: Tomoyuki ISHIKAWA, Toyota Aichi-ken (JP); Yuta HINO, Nagakute-shi Aichi-Ken (JP)

(73) Assignee: TOYOTA JIDOSHA KABUSHIK! KAISHA, Toyota-shi Aichi-ken (JP)

(21) Appl. No.: 18/378,193

(22) Filed: Oct. 10, 2023

(30) Foreign Application Priority Data
Nov. 17, 2022 (JP) 2022-184098

(51) Int. Cl. B60B 3/04; B60B 3/10

(52) U.S. Cl. CPC B60B 3/045; B60B 3/10

(57) ABSTRACT

The present disclosure includes a main body outer end which is an outer end of the rim body in the axial direction, a portion of the rim composed of a portion axially outer than the main body outer end, and a ring-shaped portion located on the innermost radial direction of the inner peripheral surface of the rim outer end portion is a rim inner peripheral end, the wall portion, so as to become a wall with respect to the air flowing axially outward along the inner peripheral surface of the rim body, the air hole and the axial direction overlapping portion of the rim inner peripheral end, an opposed portion arranged axially outward spaced apart from each other in the axial direction, extending radially outward from the opposing portion, so as to form one or more openings radially outward from the rim inner peripheral end, and an outer peripheral portion defining at least a portion of the opening.

### CROSS-REFERENCE TO RELATED APPLICATION

This application claims priority to Japanese Patent Application No. 2022-184098 filed on Nov. 17, 2022, incorporated herein by reference in its entirety.

### BACKGROUND

### 1. Technical Field

The present disclosure relates to a vehicle wheel.

### 2. Description of Related Art

A cap attached to a wheel is described, for example, in Japanese Unexamined Patent Application Publication No. 2019-147460 (JP 2019-147460 A). The cap is provided with fins and slits. As a result, the air in the vicinity of the fins is guided by the slits and is discharged to the outside from the slits. According to this cap, both aerodynamic performance and heat dissipation performance can be achieved.

### SUMMARY

However, in consideration of the air flow in the space surrounded by the rim of the wheel, the cap has room for improvement in terms of improving aerodynamic performance. An object of the present disclosure is to provide a vehicle wheel capable of improving aerodynamic performance while suppressing an increase in pressure in a rim.

A vehicle wheel according to a first aspect of the present disclosure includes a cylindrical rim, a disk, and a wall portion. The disk included a central connection portion connected to a vehicle body, and a plurality of spokes arranged to connect the rim and the central connection portion. The wall portion is disposed so as to partially close a plurality of air holes provided between the spokes. In the description, a radial direction of the rim is defined as a radial direction, and a direction parallel to a rotation axis of the rim is defined as an axial direction. In addition, a direction away from a vehicle body center line in the axial direction is defined as an axially outward direction, and a direction toward the vehicle body center line in the axial direction is defined as an axially inward direction. The rim includes a cylindrical rim body, a ring-shaped spoke connection portion, a ring-shaped outer rim flange, and a ring-shaped inner rim flange. The spoke connection portion extends axially outward and radially outward from an axially outer end portion of the rim body. The spokes are connected to the spoke connection portion. The outer rim flange is connected to an axially outer end portion of the spoke connection portion. The inner rim flange is connected to an axially inner end portion of the rim body for holding a tire together with the outer rim flange.

In the description of the present disclosure, a portion composed of a body outer end that is an axially outer end of the rim body and a portion axially outward of the body outer end of the rim is defined as a “rim outer end portion”. In addition, a ring-shaped portion located on the radially innermost side of an inner peripheral surface of the rim outer end portion is defined as a “rim inner peripheral end”. The wall portion includes a facing portion and an outer peripheral portion. The facing portion is provided so as to be spaced apart in the axially outward direction from a portion of the rim inner peripheral end that overlaps the air hole in the axial direction and provided to face the portion in the axial direction, so as to serve as a wall with respect to air flowing axially outward along an inner peripheral surface of the rim body. The outer peripheral portion extends radially outward from the facing portion. The outer peripheral portion defines at least a part of one or more openings communicating an inside and an outside of the wall portion in the axial direction, so as to provide the one or more openings radially outward from the rim inner peripheral end.

In the vehicle wheel according to the second aspect of the present disclosure, the disk includes a ring-shaped connection portion. In the description, a ring-shaped portion located on the radially innermost side of the inner peripheral surface of the connection portion is defined as an inner peripheral end. The facing portion of the wall portion is provided so as to be spaced apart in the axially outer direction from the inner peripheral end defining a part of the air hole and is provided to face the inner peripheral end in the axial direction, so as to serve as a wall with respect to air flowing axially outward along the inner peripheral surface of the connection portion. The outer peripheral portion of the wall portion extends radially outward from the facing portion. The outer peripheral portion defines at least a part of the one or more openings so as to provide the one or more openings radially outward from the inner peripheral end.

As the vehicle advances, the pressure under the floor of the vehicle increases and air tends to exit through the rim. The air in the rim is pressed against the inner peripheral surface of the rim by the centrifugal force caused by the rotation of the tire. The pressed air tends to blow out axially outward along the inner peripheral surface of the rim. According to the vehicle wheel of the first aspect of the present disclosure, the air flowing axially outward along the inner peripheral surface of the rim body is blown out from the vicinity of the rim inner peripheral end and then collides with the facing portion of the wall portion through the air hole. The air that has collided with the facing portion moves radially outward by centrifugal force, and is discharged to the space outside the rim through the opening. Further, according to the vehicle wheel of the second aspect of the present disclosure, the air flowing axially outward along the inner peripheral surface of the rim tends to flow along the inner peripheral surface of the connection portion defining the air hole and is to be blown out to the outside of the rim. After colliding with the facing portion of the wall portion, the air to be blown out to the outside of the rim moves radially outward and is discharged out of the rim through the opening.

According to the first aspect or the second aspect, the air in the rim is suppressed from blowing out perpendicularly to the side flow (vehicle side flow). That is, the air in the rim is suppressed from being discharged parallel to the axial direction. This makes it possible to reduce the air resistance during traveling of the vehicle. Further, since the air in the rim is discharged from the opening, the cooling performance of the brake disposed in the rim is maintained, and the increase in the pressure in the rim is suppressed. As described above, according to the vehicle wheel of the present disclosure, it is possible to improve aerodynamic performance while suppressing an increase in pressure in the rim.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a configuration diagram of a vehicle wheel according to a first embodiment;

FIG. 2 is a conceptual diagram showing the vehicle of the first embodiment;

FIG. 3 is a conceptual diagram illustrating a cross section of a rim and a cap according to the first embodiment;

FIG. 4 is a cross-sectional view of a portion of the rim and cap of the first embodiment;

FIG. 5 is a conceptual diagram illustrating a cap of a variation of the first embodiment;

FIG. 6 is a conceptual diagram showing a wall portion of a modification of the first embodiment;

FIG. 7 is a conceptual diagram illustrating a cap according to a modification of the first embodiment;

FIG. 8 is a conceptual diagram illustrating a cap according to a modification of the first embodiment;

FIG. 9 is a conceptual diagram for explaining a wall portion of the second embodiment;

FIG. 10 is a conceptual diagram for explaining a wall portion of the second embodiment;

FIG. 11 is a conceptual diagram showing a cross section of a vehicle wheel according to a third embodiment; and

FIG. 12 is a configuration diagram of an auxiliary cap according to the second embodiment.

### DETAILED DESCRIPTION OF EMBODIMENTS

Hereinafter, a vehicle wheel according to an embodiment of the present disclosure will be described in detail with reference to the drawings as an embodiment for carrying out the present disclosure. In addition to the embodiments described below, the present disclosure can be implemented in various forms in which various changes and improvements are made based on the knowledge of a person skilled in the art.

### First Embodiment

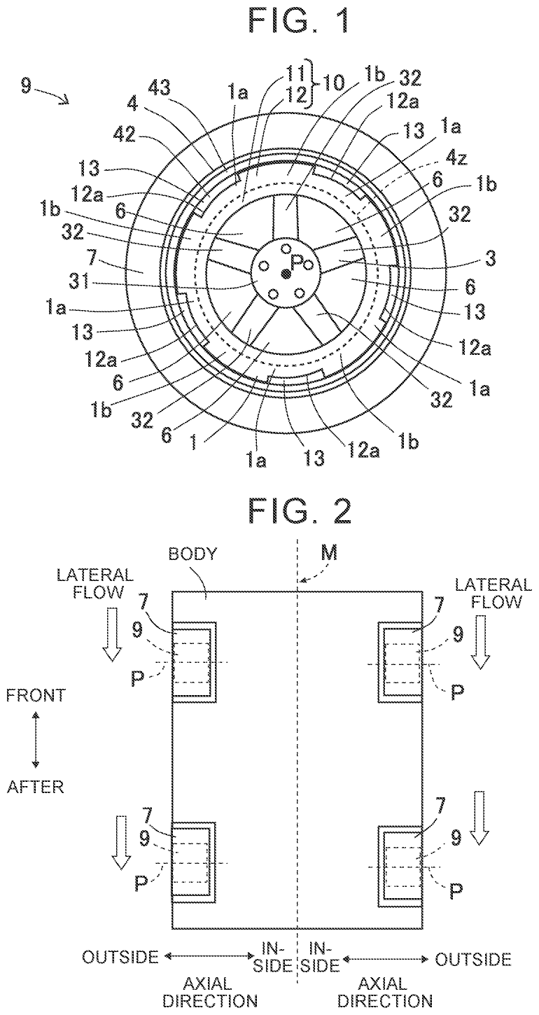

As shown in FIG. 1, the vehicle wheel 9 includes a disk 3, a cylindrical rim 4, and a cap 1. The disk 3 includes a central connection portion 31 connected to the vehicle body, and a plurality of spokes 32. The disk 3 and the rim 4 of the first embodiment are of a one-piece type. The disk 3 and the rim 4 of the first embodiment are integrally formed. The central connection portion 31 is located at a central portion of the disk 3. The central connection portion 31 is attached to, for example, a hub of a vehicle body. The center of the central connection portion 31 is located on the rotation axis P of the disk 3 and the rim 4. Hereinafter, a radial direction of the rim 4 is referred to as a radial direction, and a direction parallel to the rotation axis P is referred to as an axial direction as illustrated in FIG. 2. The radial direction and the axial direction are orthogonal to each other. In addition, a direction approaching the vehicle body center line M in the axial direction is referred to as an axial direction inner side. A direction away from the vehicle body center line M is referred to as an axial direction outer side. The vehicle body center line M is an imaginary straight line extending in the front-rear direction through the center of the vehicle body. The circumferential direction of the rim 4 is simply referred to as a circumferential direction. Note that the “rim 4” in the above-described direction definition can be replaced with “disk 3”.

The plurality of spokes 32 is arranged so as to connect the rim 4 and the central connection portion 31. The plurality of spokes 32 extend radially from the central connection portion 31. A plurality of air holes 6 is formed between the plurality of spokes 32. In the first embodiment, the air hole 6 is partitioned by the two spokes 32, the central connection portion 31, and the rim 4. The air hole 6 may be partitioned by, for example, two spokes 32 and the rim 4 depending on the arrangement and shape of the spokes 32.

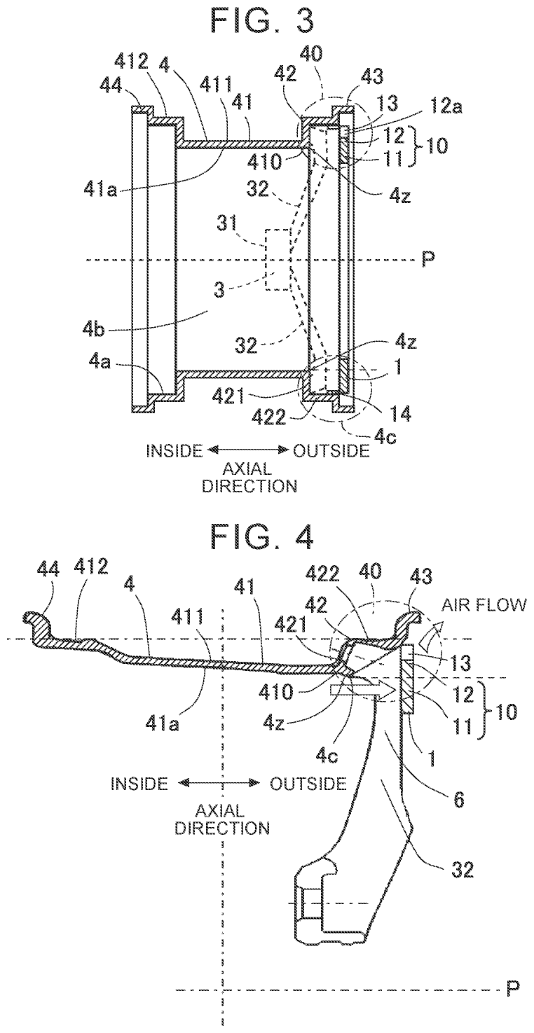

As shown in FIG. 3, the rim 4 is formed in a cylindrical shape as a whole. FIG. 3 corresponds to a cross section obtained by cutting the vehicle wheel in a plane including the rotation axis P. A tire 7 is held in the rim 4. A space surrounded by the inner peripheral surface 4a of the rim 4 is referred to as an inner space 4b of the rim. The rim 4 includes a cylindrical rim body 41, a spoke connection portion 42, an outer rim flange 43, and an inner rim flange 44. The rim body 41 is a cylindrical portion that constitutes an axial central portion of the rim 4.

At least a portion of the rim body 41 constitutes the well 411. In the first embodiment, the portion including the axially outer end portion of the rim body 41 is the well 411. The well 411 is a portion provided mainly for ease of assembling the tire. The well 411 can be said to be a portion of the rim body 41 that is recessed inward in the radial direction. The well 411 is also referred to as a drop well. The inner end portion of the rim body 41 in the axial direction constitutes the inner bead seat portion 412.

The spoke connection portion 42 extends axially outward and radially outward from an axially outer end of the rim body 41. The spoke connection portion 42 is a portion of the rim 4 to which the plurality of spokes 32 is connected. In other words, the spoke connection portion 42 is a ring-shaped portion in which the plurality of spokes 32 is in contact with each other. More specifically, the spoke connection portion 42 includes a step forming portion 421 and a bead seat portion 422.

The step forming portion 421 extends radially outward from an outer end portion of the well 411 in the axial direction. The hole of the step forming portion 421 shown in FIG. 4 is a valve hole. The bead seat portion 422 extends axially outward from a radially outer end portion of the step forming portion 421. The bead seat portion 422 is a portion where the bead portion of the tire 7 comes into close contact with each other. A hump portion may be formed at a connection portion between the step forming portion 421 and the bead seat portion 422. In the first embodiment, the plurality of spokes 32 is integrally formed with the rim 4.

The outer rim flange 43 has a ring shape. The outer rim flange 43 is connected to an axial outer end portion of the spoke connection portion 42. The outer rim flange 43 of the first embodiment extends axially outward and radially outward from the axially outer end of the spoke connection portion 42. The outer rim flange 43 constitutes an axial outer end portion of the rim 4.

The inner rim flange 44 has a ring shape. The inner rim flange 44 is connected to an inner end portion of the rim body 41 in the axial direction. The inner rim flange 44 of the first embodiment extends axially inward and radially outward from the axially inner end of the rim body 41. The inner rim flange 44 constitutes an inner end portion of the rim 4 in the axial direction. The inner rim flange 44 is configured to hold the tire 7 together with the outer rim flange 43.

In the description, a body outer end 410 which is an outer end in the axial direction of the rim body 41, a portion composed of the outer portion of the rim 4 axially outer than the body outer end 410 referred to as the rim outer end portion 40. The body outer end 410 is a portion of the rim body 41 that is connected to the spoke connection portion 42. That is, it can be said that the spoke connection portion 42 extends radially outward from the body outer end 410. The rim outer end portion 40 includes a body outer end 410, a spoke connection portion 42, and an outer rim flange 43. Further, in the explanation, a ring-shaped part of the inner circumferential surface of the rim outer end portion 40 located on the radially innermost side is referred to as a rim inner peripheral end 4z.

As shown in FIG. 4, the rim 4 of the first embodiment is formed with a ring-shaped protruding portion 4c protruding further axially outward from the body outer end 410. The protruding portion 4c is part of the rim-outer end 40. The inner circumferential surface of the protruding portion 4c is located radially inward of the inner circumferential surface of the rim body 41. A part of the inner peripheral surface of the rim outer end portion 40 located on the radially innermost side is an inner peripheral surface of the protruding portion 4c. Therefore, the rim inner peripheral end 4z of the first embodiment is constituted by the inner peripheral surface of the protruding portion 4c. In this manner, when the rim 4 includes the protruding portion 4c, the rim inner peripheral end 4z may be an inner peripheral surface of the protruding portion 4c. In the one-piece type vehicle wheel, when the rim 4 does not include the protruding portion 4c, it can be presumed that the inner peripheral surface of the body outer end 410 often becomes the rim inner peripheral end 4z.

As shown in FIG. 1, the cap 1 is a member that partially covers the disk 3. The cap 1 is attached to at least one of the disk 3 and the rim 4. The cap 1 of the first embodiment is formed in a ring shape. The cap 1 is disposed on an axially outer side of the plurality of spokes 32. By disposing the cap 1 with respect to the disk 3, an increase in air resistance caused by the spokes 32 during vehicle running is suppressed. The aerodynamic performance is also improved. The front surface means an axially outer surface, and the back surface means an axially inner surface.

The cap 1 includes a plurality of overlapping areas 1a and a plurality of non-overlapping areas 1b. The overlapping area 1a is an axially overlapping part of the air hole 6. The non-overlapping area 1b is a part that does not axially overlap the air hole 6. In the first embodiment, the non-overlapping area 1b is an axially overlapping part of the spokes 32.

The cap 1 includes a wall portion 10. The wall portion 10 is composed of all the overlapping areas 1a. The wall portion 10 is arranged to partially block the plurality of air holes 6. The wall portion 10 includes a facing portion 11 and an outer peripheral portion 12. The facing portion 11 is disposed so as to be a wall with respect to the airflow axially outward along the inner peripheral surface 41a of the rim body 41. More specifically, the facing portion 11 is disposed to be spaced axially outward and axially opposed to a part of the rim inner peripheral end 4z that overlaps the air hole 6 in the axial direction. That is, the facing portion 11 is arranged so as not to form an opening for communicating the inside and the outside of the wall portion 10 in the axial direction. An opening 13, which will be described later, is not formed in the facing portion 11.

The facing portion 11 is disposed so as to cover a part of the rim inner peripheral end 4z that axially overlaps with the air hole 6. The facing portion 11 covers the rim inner peripheral end 4z together with the plurality of spokes 32 so that the rim inner peripheral end 4z is not exposed through the air hole 6 in the axial direction.

The facing portion 11 functions as a wall with respect to air that is blown out axially outward from the vicinity of the inner peripheral end 4z of the rim. The facing portion 11 has a predetermined width in the radial direction, and also faces the space on the inner side in the radial direction and the space on the outer side in the radial direction on the rim inner peripheral end 4z. The rim inner peripheral end 4z is opposed to a part of the facing portion 11 excluding both the radially inner edge and the radially outer edge. The facing portion 11 is configured such that the air blown out axially outward along the inner peripheral surface 41a of the rim body 41 collides with each other.

The outer peripheral portion 12 extends radially outward from the facing portion 11. The outer peripheral portion 12 defines at least a portion of the opening 13 so as to form one or more openings 13 that communicate the inside and the outside of the wall portion 10 in the axial direction radially outward of the rim inner peripheral end 4z. In the first embodiment, one or more slits 12a are formed in the outer peripheral part of the cap 1. That is, one or more slits 12a are formed in the outer peripheral portion 12. The one or more openings 13 are delimited by one or more slits 12a and a rim 4. The slit 12a is formed so as to be recessed radially inward from a radially outer edge of the cap 1.

In the first embodiment, one slit 12a is formed for one overlap area 1a. That is, in the vehicle wheel 9 of the first embodiment, a plurality of slits 12a and openings 13 corresponding to the plurality of air holes 6 are formed. In the first embodiment, five slits 12a and five openings 13 are formed corresponding to the five air holes 6. In this embodiment, since the spokes 32 are arranged at equal intervals in the circumferential direction, the slit 12a are also arranged at equal intervals in the circumferential direction. Note that the positions of the slits 12a and the opening 13 may not be equally spaced. For example, the arrangement of the openings 13 can vary depending on the arrangement of the spokes 32.

The one or more openings 13 are formed so that, in total, the circumferential length is greater than the radial length. In the first embodiment, the sum of the circumferential lengths of the respective slit 12a is larger than the sum of the radial lengths of the respective slit 12a. Further, the respective slit 12a are formed such that the length in the circumferential direction is larger than the length in the radial direction. Therefore, for each opening 13, the length in the circumferential direction is larger than the length in the radial direction. Note that the shape of the opening 13 is not limited to the above-described horizontally long shape, and may be another shape.

Am attachment portion 14 extending axially inward is formed on the rear surface of the cap 1. The attachment portion 14 is a portion used to attach the cap 1 to at least one of the disk 3 and the rim 4. As an example, a wiring (not shown) is attached to the attachment portion 14. The cap 1 is attached to the rim 4 by an attachment portion 14 and a wiring ring. The attachment portion 14 is not limited to the above, and may be formed to engage with the disk 3, for example, the spoke 32. This eliminates the need for wiring. In addition, the disk 3 and the cap 1 may be integrally formed.

The flow of air in the vehicle wheel 9 during vehicle travel will be described. As the vehicle advances, the pressure under the floor of the vehicle increases and air tends to exit through the rim. Air in the rim body 41 is pressed against the inner peripheral surface 41a of the rim body 41 by centrifugal force caused by the tire 7 rotating. Air pressed against the inner peripheral surface 41a tends to move axially outward due to an increase in internal pressure while moving in the rotational direction of the tire 7. In other words, the air accumulated in the in-rim space 4b mainly tends to blow out along the inner peripheral surface 41a in the axial direction.

On the other hand, in a space outside the rim, which is a space outside the rim 4 in the axial direction, air flows from the front toward the rear along the side surface of the tire 7 as the vehicle advances (see FIG. 2). This flow of air is referred to as a side flow. The air discharged from the inside of the rim 4 to the outside in the axial direction collides with the side flow, and becomes an air resistance during the traveling of the vehicle.

According to the first embodiment, the air blown out axially outward along the inner peripheral surface 41a by the centrifugal force once collides with the facing portion 11 of the wall portion 10. That is, the air blown out axially outward from the vicinity of the inner peripheral end 4z of the rim collides with the facing portion 11. Then, the collided air is discharged to the outside space of the wheel through the opening 13 while moving radially outward of the cap 1 by centrifugal force. That is, the traveling direction of the air discharged from the inside of the rim body 41 during the traveling of the vehicle is changed in a direction inclined from the rotation axis P. When the wall portion 10 is not provided, the air discharged from the inside of the rim body 41 during the traveling of the vehicle is easily discharged in the axial direction, that is, in parallel to the rotation axis P through the air hole 6. According to this, the discharge flow collides perpendicularly to the side flow, and the air resistance increases.

However, according to the first embodiment, the air whose momentum is weakened axially outward due to the collision with the facing portion 11 is discharged to the outside of the in-rim space 4b through the opening 13. According to the first embodiment, the air in the rim body 41 is prevented from blowing out perpendicularly to the side flow. Thus, it is possible to reduce the adverse effect on the side flow due to the air discharge, it is possible to reduce the air resistance. According to the first embodiment, it is possible to suppress air accumulated in the rim body 41 from being blown out in the axial direction. According to the first embodiment, the air in the rim body 41 is suppressed from being vigorously discharged in the vehicle left-right direction while the vehicle is traveling straight. That is, according to the first embodiment, aerodynamic performance can be improved. Further, the air in the rim body 41 is discharged from the opening 13. Therefore, the increase in the pressure inside the rim 4 is suppressed while the cooling performance of the brake disposed in the rim body 41 is maintained. As described above, according to the first embodiment, it is possible to improve aerodynamic performance while suppressing an increase in pressure in the rim 4.

In addition, according to the first embodiment, the respective openings 13 are partitioned by the rims 4 and the slits 12a. By using the rim 4 as a part of the partition member, it is easy to secure the passage area of the opening 13. In addition, since the wall portion 10 is constituted by the cap 1, it can be easily attached to the existing disk 3 or the rim 4. Further, by forming a laterally long slit 12a whose circumferential length is larger than the radial length, the passage area of the opening 13 is easily secured. The opening 13 cannot be formed in the facing portion 11. Therefore, in some embodiments, from the viewpoint of securing the passage area, the opening 13 is in a horizontally long shape.

### Other Aspects of the First Embodiment

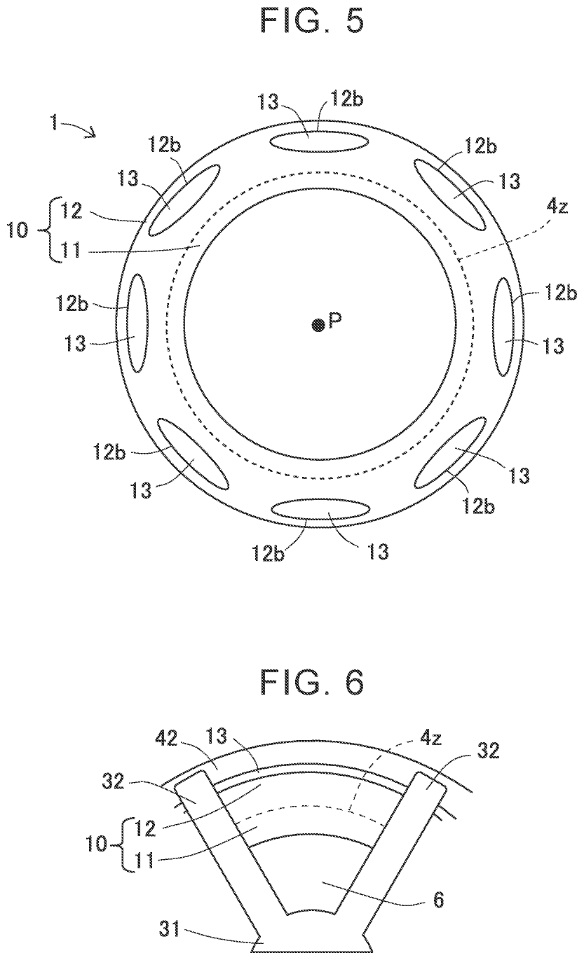

The cap 1 may be disposed, for example, on an axially outer side of the outer rim flange 43. Further, as shown in FIG. 5, the one or more openings 13 may be partitioned by a through-hole 12b formed in the outer peripheral portion 12.

Further, as shown in FIG. 6, the vehicle wheel 9 may include the wall portion 10 integrally formed with at least one of the disk 3 and the rim 4 without the cap 1. The wall portion 10 of FIG. 6 is integrally formed with the disk 3 so as to connect between two adjacent spokes 32 in each air hole 6. The wall portion 10 extends from the spoke 32 to an adjacent spoke 32. The wall portion 10 is disposed between two adjacent spokes 32. The facing portion 11 extends in the circumferential direction from the spoke 32 to the adjacent spoke 32 so as to be axially opposed to the rim inner peripheral end 4z. The outer peripheral portion 12 partitions at least a part of the opening 13 on the outer peripheral side of the facing portion 11.

In the example of FIG. 6, each opening 13 is defined by an outer peripheral portion 12, a rim 4, and two spokes 32. Even in the configuration as shown in FIG. 6, the same effects as described above can be exerted. As described above, the wall portion 10 is not limited to being formed of the cap 1, and may be formed integrally with at least one of the disk 3 and the rim 4.

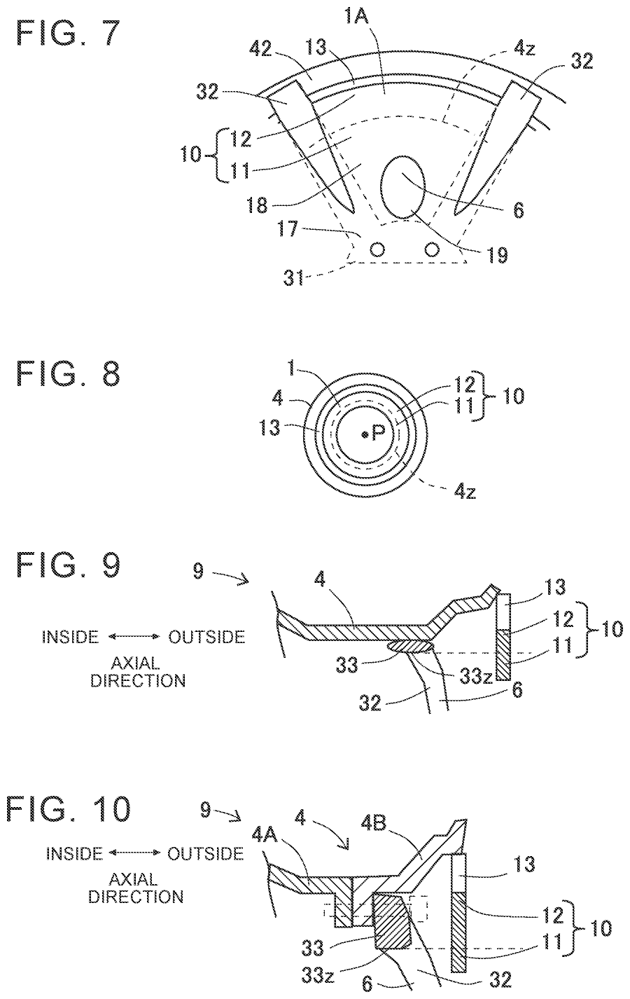

As shown in FIG. 7, the capping 1A may be formed by a central portion 17 and a plurality of wing portions 18 extending radially from the central portion 17 so as to block the air hole 6. The wing portion 18 includes a wall portion 10. Also with this configuration, the same effects as described above can be exhibited. Note that a through hole 19 may be formed in a portion of the capping 1A corresponding to the radially inner portion of the air hole 6. For example, the central portion 17 of the capping 1A and the central connection portion 31 of the disk 3 are connected.

Further, although not shown, individual caps having the wall portions 10 may be arranged for the respective air holes 6. That is, individual caps may be attached to the plurality of air holes 6. In this case, the number of air holes 6 and the number of caps are equal. That is, the vehicle wheel may include a plurality of caps corresponding to the plurality of air holes 6. In this case, the shape of the cap may be a shape (for example, a fan shape) corresponding to the shape of the corresponding air hole 6.

Further, as shown in FIG. 8, without forming a slit 12a in the cap 1, one opening 13 may be partitioned by the circular outer peripheral portion 12 and the rim 4. The cap 1 is arranged so that the entire circumference of the outer peripheral portion 12 and the entire circumference of the rim 4 are separated from each other, so that one ring-shaped opening 13 is formed. The cap 1 can be fixed to the spoke 32, for example. Also with this configuration, the same effects as described above can be exhibited. In FIG. 8, the display of the disk 3 is omitted.

### Second Embodiment

As shown in FIG. 9, the disk 3 and the rim 4 may be of two-piece type. In the two-piece type, the disk 3 and the rim 4 are formed separately and then joined together. Further, as shown in FIG. 10, the disk 3 and the rim 4 may be of a three-piece type. In the three-piece type, the rim 4 is formed by joining an inside rim 4A and an outside rim 4B that are separate from each other. That is, in the three-piece type, the inside rim 4A, the outside rim 4B, and the disk 3 are formed separately from each other.

In a two-piece or three-piece form, the disk 3 is configured to include a central connection portion 31, a connection portion 33, and a plurality of spokes 32. The connection portion 33 is a ring-shaped portion connected to the rim 4. Each spoke 32 is arranged so as to connect the central connection portion 31 and the connection portion 33. In the explanation, the ring-shaped part located on the radially innermost side of the inner peripheral surface of the connection portion 33 is referred to as an inner peripheral end 33z. The inner peripheral end 33z partitions the radially outer end portion of the air hole 6.

The wall portion 10 includes a facing portion 11 and an outer peripheral portion 12. The facing portion 11 is disposed so as to be a wall with respect to air flowing axially outward along the inner peripheral surface of the connection portion 33. More specifically, the facing portion 11 is disposed to be spaced apart from the inner peripheral end 33z that defines a part of the air hole 6 in the axial direction and to be opposed to the axial direction. The facing portion 11 is disposed so as to cover the inner peripheral end 33z. The facing portion 11 is arranged so as not to form an opening for communicating the inside and the outside of the wall portion 10 in the axial direction. That is, the opening 13 is not formed in the facing portion 11. The facing portion 11 is arranged such that the inner peripheral end 33z is not exposed in the axial direction.

In the example of FIGS. 9 and 10, similar to the first embodiment, the ring-shaped cap 1 is arranged with respect to the disk 3 and the rim 4. As in the first embodiment, a part of the cap 1 constitutes the wall portion 10. The outer peripheral portion 12 extends radially outward from the facing portion 11 and defines at least a portion of the opening 13 so as to form one or more openings 13 radially outward from the inner peripheral end 33z.

According to this configuration, during the forward movement of the vehicle, the air in the rim 4 tends to blow out from the outer peripheral part of the air hole 6, that is, from the vicinity of the inner peripheral end 33z of the connection portion 33 to the axially outer side by centrifugal force. As in the first embodiment, the air collides with the facing portion 11 and is discharged to the outside of the rim 4 through the radially outer opening 13. As a result, the same effects as those of the first embodiment can be exhibited in the second embodiment. The wall portion 10 may be formed integrally with the disk 3, for example. As with the other aspects of the first embodiment, the aspects of the wall portion 10 of the second embodiment are variable. In some embodiments, as shown in FIGS. 9 and 10, the facing portion 11 is arranged to face not only the inner peripheral end 33z but also the axially outer edge of the inner peripheral surface of the connection portion 33 in the axial direction.

### Third Embodiment

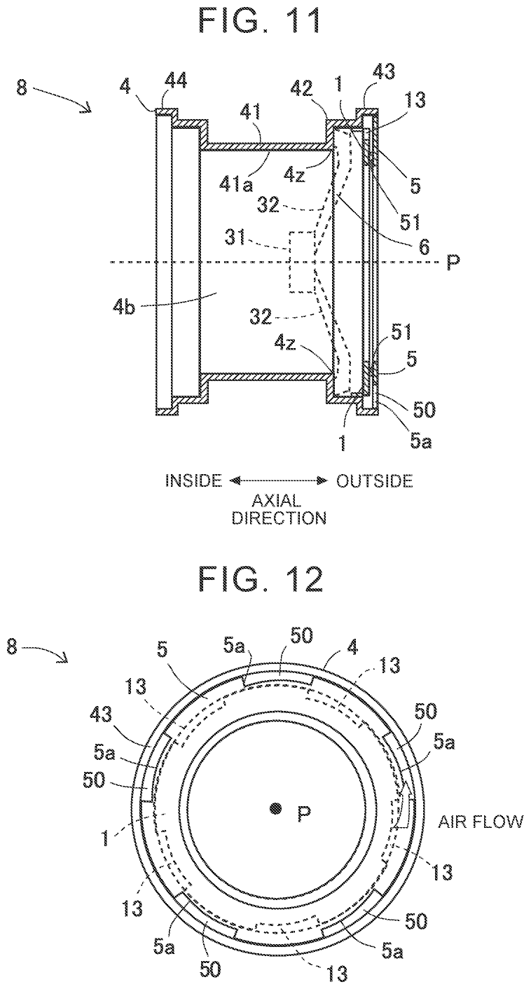

As shown in FIGS. 11 and 12, the vehicle wheel 8 of the third embodiment includes an auxiliary cap 5 in addition to the configuration of the vehicle wheel 9 of the first embodiment. That is, the vehicle wheel 8 includes a disk 3, a rim 4, a cap 1, and an auxiliary cap 5. The auxiliary cap 5 can also be applied to the vehicle wheel 9 of the second embodiment.

The auxiliary cap 5 is disposed on the outer side in the axial direction of the cap 1 so as to cover the cap 1. The auxiliary cap 5 is formed in a ring shape. The auxiliary cap 5 includes an engaging portion 51 that protrudes inward in the axial direction from the rear surface of the auxiliary cap 5 and engages with the cap 1. The auxiliary cap 5 is formed with a plurality of auxiliary openings 50 corresponding to the plurality of openings 13. In the auxiliary cap 5 of the third embodiment, five auxiliary openings 50 are formed. That is, in the third embodiment, the opening 13 and the auxiliary opening 50 correspond to each other in a one-to-one manner. The numerical value of the auxiliary opening 50 may be different from the numerical value of the opening 13.

Each auxiliary opening 50 is located at the same position as the opening 13 in the radial direction, or is located radially outward of the opening 13. In the example of FIGS. 11 and 12, the plurality of auxiliary openings 50 is located radially outward of the plurality of openings 13. Further, each auxiliary opening 50 is formed at a position different from the opening 13 in the circumferential direction. The position of the opening means a center position in the circumferential direction of the opening. In this example, the auxiliary opening 50 and the opening 13 do not overlap in the axial direction. That is, the wall surface of the auxiliary cap 5 is disposed on the axial outer side of the plurality of openings 13. The auxiliary opening 50 and the opening 13 may partially or entirely overlap in the axial direction. The auxiliary opening 50 is defined by a slit 5a formed at the radially outer end of the auxiliary cap 5 and an outer rim flange 43.

According to the third embodiment, the air discharged from the opening 13 collides with the wall surface of the auxiliary cap 5, and the traveling direction is further changed. The air between the cap 1 and the auxiliary cap 5 is moved in the circumferential direction by the rotation of the tire 7. That is, the air moves in the circumferential direction and is discharged from the auxiliary opening 50 to the outside of the rim 4. As a result, the flow direction of the air discharged from the inside of the rim 4 to the outside of the rim 4 tends to be in the direction along the side flow. That is, according to the third embodiment, the air resistance can be reduced.

Further, in the present example, the auxiliary opening 50 is located radially outward of the opening 13. The center position of the auxiliary opening 50 in the radial direction is located radially outward of the center position of the opening 13 in the radial direction. Thus, even when the air between the cap 1 and the auxiliary cap 5 moves in the circumferential direction while moving radially outward due to the centrifugal force, the air can be smoothly discharged.

Further, the auxiliary opening 50 is defined by the rim 4 and the slit 5a. This facilitates securing the passage area of the auxiliary opening 50. In addition, the auxiliary opening 50 is formed horizontally long like the opening 13. This facilitates securing the passage area of the auxiliary opening 50. In addition, by making the auxiliary opening 50 and the opening 13 correspond to each other in a one-to-one manner, air can be easily discharged smoothly. The auxiliary opening 50 may be partitioned by a through hole provided in the auxiliary cap 5. The cap 1 and the auxiliary cap 5 may be integrally formed. Further, the auxiliary cap 5 may be attached to the rim 4 by wiring or the like. Even if the auxiliary opening 50 and the opening 13 overlap in the axial direction, the flow direction of at least a part of the air can be changed by the auxiliary cap 5. In each embodiment, the material of each portion of the vehicle wheel including the wall portion 10 can be arbitrarily set. The auxiliary cap 5 may be arranged axially outside the outer rim flange 43. For example, the cap 1 or the auxiliary cap 5 may be mounted over the outer rim flange 43. Further, the shape of the wall portion 10 is not limited to the above example. For example, the facing portion 11 may be configured to function as a wall with respect to air that is to be blown out from the air hole 6 in the axial direction toward the outside of the rim 4. The facing portion 11 may include a grid, a net, a small through hole, or the like configured to substantially prevent the passage of the air having momentum toward the outside in the axial direction during the traveling of the vehicle.

What is claimed is:

1. A vehicle wheel comprising:
a cylindrical rim;
a disk including a central connection portion connected to a vehicle body, and a plurality of spokes arranged to connect the rim and the central connection portion; and
a wall portion disposed so as to partially close a plurality of air holes provided between the spokes, wherein
when a radial direction of the rim is defined as a radial direction, a direction parallel to a rotation axis of the rim is defined as an axial direction, a direction away from a vehicle body center line in the axial direction is defined as an axially outward direction, and a direction toward the vehicle body center line in the axial direction is defined as an axially inward direction, the rim includes
a cylindrical rim body,
a ring-shaped spoke connection portion extending axially outward and radially outward from an axially outer end portion of the rim body, the spokes being connected to the spoke connection portion,
a ring-shaped outer rim flange connected to an axially outer end portion of the spoke connection portion, and
a ring-shaped inner rim flange connected to an axially inner end portion of the rim body for holding a tire together with the outer rim flange, and
when a portion composed of a body outer end that is an axially outer end of the rim body and a portion axially outward of the body outer end of the rim is defined as a rim outer end portion, and a ring-shaped portion located on the radially innermost side of an inner peripheral surface of the rim outer end portion is defined as a rim inner peripheral end, the wall portion includes
a facing portion provided so as to be spaced apart in the axially outward direction from a portion of the rim inner peripheral end that overlaps the air hole in the axial direction, the facing portion provided to face the portion in the axial direction, so as to serve as a wall with respect to air flowing axially outward along an inner peripheral surface of the rim body, and
an outer peripheral portion extending radially outward from the facing portion and defining at least a part of one or more openings communicating an inside and an outside of the wall portion in the axial direction, so as to provide the one or more openings radially outward from the rim inner peripheral end.

2. The vehicle wheel according to claim 1, wherein the openings are defined by the outer peripheral portion and the rim, or the outer peripheral portion, the rim, and the spokes.

3. The vehicle wheel according to claim 1, further comprising a cap attached to at least one of the rim and the disk, wherein the wall portion is constituted by at least a part of the cap.

4. The vehicle wheel according to claim 1, further comprising a ring-shaped auxiliary cap disposed axially outward of the wall portion so as to be spaced apart from the wall portion in the axial direction and so as to cover the wall portion, wherein
a plurality of the openings is provided,
the auxiliary cap is provided with a plurality of auxiliary openings corresponding to the plurality of the openings, and
each of the auxiliary openings is located at the same radial position as the openings or is located radially outward of the openings.

5. A vehicle wheel comprising:
a cylindrical rim;
a disk including a central connection portion connected to a vehicle body, a ring-shaped connection portion connected to the rim, and a plurality of spokes arranged to connect the central connection portion and the connection portion; and
a wall portion disposed so as to partially close a plurality of air holes provided between the spokes, wherein
when a radial direction of the rim is defined as a radial direction, a direction parallel to a rotation axis of the rim is defined as an axial direction, a direction away from a vehicle body center line in the axial direction is defined as an axially outward direction, a direction toward the vehicle body center line in the axial direction is defined as an axially inward direction, and a ring-shaped portion located on the radially innermost side of the inner peripheral surface of the connection portion is defined as an inner peripheral end, the wall portion includes
a facing portion provided so as to be spaced apart in the axially outer direction from the inner peripheral end defining a part of the air hole, the facing portion provided to face the inner peripheral end in the axial direction, so as to serve as a wall with respect to air flowing axially outward along the inner peripheral surface of the connection portion, and
an outer peripheral portion extending radially outward from the facing portion and defining at least a part of one or more openings communicating an inside and an outside of the wall portion in the axial direction, so as to provide the one or more openings radially outward from the inner peripheral end.

6. The vehicle wheel according to claim 5, wherein the openings are defined by the outer peripheral portion and the rim, or the outer peripheral portion, the rim, and the spokes.

7. The vehicle wheel according to claim 5, further comprising a cap attached to at least one of the rim and the disk, wherein the wall portion is constituted by at least a part of the cap.

8. The vehicle wheel according to claim 5, further comprising a ring-shaped auxiliary cap disposed axially outward of the wall portion so as to be spaced apart from the wall portion in the axial direction and so as to cover the wall portion, wherein
a plurality of the openings is provided,
the auxiliary cap is provided with a plurality of auxiliary openings corresponding to the plurality of the openings, and
each of the auxiliary openings is located at the same radial position as the openings or is located radially outward of the openings.
